(19) United States
(12) Patent Application Publication
(10) Pub. No.: US 2020/0156874 A1
(43) Pub. Date: May 21, 2020

(54) Splash Guard Hold Down Bearing for Moving Floor Slat

(71) Applicant: Keith Manufacturing Co., Madras, OR (US)

(72) Inventors: Loren Friend, Madras, OR (US); John Cook, Madras, OR (US)

(73) Assignee: Keith Manufacturing Co., Madras, OR (US)

(21) Appl. No.: 16/455,322

(22) Filed: Jun. 27, 2019

Related U.S. Application Data
(60) Provisional application No. 62/692,261, filed on Jun. 29, 2018.

(51) Int. Cl. B65G 25/06

(52) U.S. Cl. CPC B65G 25/065

(57) ABSTRACT

A plastic splash guard hold down bearing for a moving floor conveyor has opposing hooks that clip onto an underlying support. The bearing presents a flat top surface for allowing a floor slat to slide back and forth as part of a moving floor conveyor. The plastic material and bearing construction is sufficient flexible to clip the bearing onto the support.

### TECHNICAL FIELD

This disclosure relates to reciprocating floor slat conveyor systems, generically known as “moving floors.” More specifically, this disclosure relates to bearings for moving floor slats.

### BACKGROUND

The reciprocating floor slats in moving floor systems typically ride on top of bearings. The bearings are supported by an aluminum sub deck. The sub deck typically consists of aluminum channel extrusions that are mounted to underlying cross members in a floor framework (e.g., a trailer floor frame).

Specialized “anti-splash” bearings have been developed for certain kinds of moving floor applications. However, these applications, to date, have been used in moving floor installations where the individual floor slats are narrower in width (resulting in a larger number of slats from side-to-side in the conveyor system as a whole).

The present disclosure offers an improved splash guard hold down bearing that enables a splash guard design to be used in connection with wider floor slats. At the same time, this disclosure describes floor slat designs that might be suitable for use in combination with the improved splash guard hold down bearing(s) disclosed and described here.

### SUMMARY

This disclosure relates to a splash guard hold down bearing that is to be used in connection with a moving floor conveyor. Moving floor conveyors have a plurality of floor slats that typically reciprocate back and forth while riding on underlying bearing surfaces.

The splash guard bearing, or bearing, includes a top flat portion that supports the floor slat. The top flat portion has an underside that includes a plurality of length-wise grooves and ridges, with the ridges shaped to rest on a horizontal surface of an underlying channel member. The horizontal surface (of the underlying channel member) is typically formed as an elongated, rectangular table that makes up the top of a vertical channel web. It generally has a defined width, as well as length, and a defined edge thickness.

The bearing has a first hook portion, adjacent to one side of the bearing's top flat portion. The purpose of the first hook portion is to enable it to clip onto on edge or similar region of the horizontal surface of the underlying channel member, as just described above.

A sidewall portion of the bearing is adjacent to another side of the bearing's top flat portion. The sidewall portion has an integrated second hook portion that clips onto an opposite edge of the channel member's horizontal surface, for connecting the bearing to the channel member. In order to accomplish this, the first and second hook portions just described are opposite each other or oppose each other.

The sidewall portion of the bearing extends downwardly and terminates as a horizontal seal portion, or a foot, that is shaped to rest on a member of an underlying support or framework. A lower region of the sidewall portion is shaped to have or define an outwardly facing notch, the location of which is vertically above the foot. The purpose of the notch is to capture a horizontal foot of the floor slat. In an alternative version, the sidewall portion of the bearing may be angled downwardly and outwardly in a region between the second hook portion and the notch.

In order to clip the bearing onto the underlying channel member, the bearing is made of a plastic material that has sufficient flexibility so that the first and second hook portions can elastically flex apart as the bearing is pushed down over the horizontal surface of the underlying channel member.

The foregoing summary will become better understood upon review of the accompanying drawings and description.

### BRIEF DESCRIPTION OF THE DRAWINGS

In the drawings, like reference numbers refer to like parts throughout, unless indicated otherwise, and wherein:

FIG. 1 is a cross-sectional view of a pair of splash guard hold down bearings, in accordance with the present disclosure, that support a floor slat on an aluminum sub deck;

FIG. 2 is a cross-sectional view of one of the bearings illustrated in FIG. 1;

FIG. 3 is a cross-sectional view similar to FIG. 1, but shows a series of floor slats supported by bearings in side-by-side configuration;

FIG. 4 is a cross-sectional view similar to FIG. 3, but shows an entire moving floor system as it might be typically installed in the floor of a trailer;

FIG. 5 is a cross-sectional view of an aluminum channel that is used to make up an aluminum sub deck in a moving floor system; and

FIG. 6 is a cross-sectional view of an aluminum floor slat.

### DETAILED DESCRIPTION

Reference numeral 10, in FIG. 2, generally points to the splash guard hold down bearing that is the subject of the present disclosure.

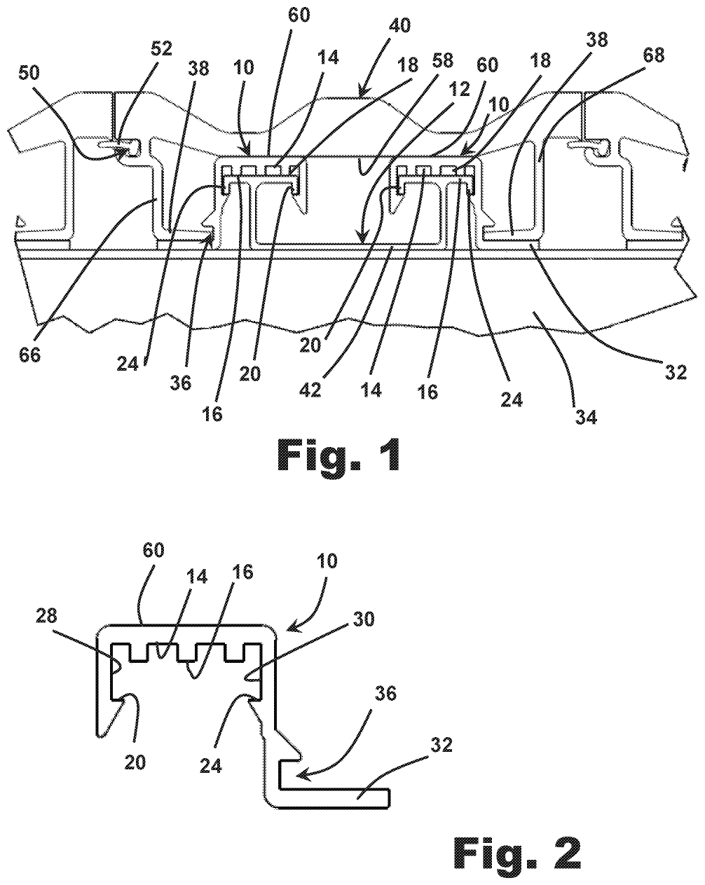

The bearing 10 is snapped on to one side of an aluminum channel, indicated generally by reference numeral 12. Referring now to FIG. 1, the bearing 10 has length-wise grooves and ridges 14, 16, with the ridges 16 resting on a horizontal surface 18, on each side of the aluminum channel 12. As is apparent in FIG. 1, the bearing 10 on the right-hand side of the channel 12 is mirrored on the left-hand side.

Each bearing 10 has a hook 20 that clips onto a vertical edge portion 22 on one side of the aluminum channel's horizontal surface 18; and a similar hook 24 that clips onto a vertical edge portion 26 on the opposite side (of the aluminum channel 12). The bearing 10 is made of a plastic material with sufficient flexibility that sidewalls 28, 30 of the bearing will flex apart as the bearing is pushed down over horizontal surface 18 (of the channel 12) and snapped into place via the hooks 20, 24 on each side of the bearing 10.

The bearing 10 also has a horizontal seal portion 32 that rests on cross members 34 of an underlying support framework. A notch (indicated generally by reference numeral 36) is formed above the horizontal seal portion 32 for capturing a horizontal foot 38 of a floor slat, one on each side of the floor slat. The floor slat is indicated generally at 40.

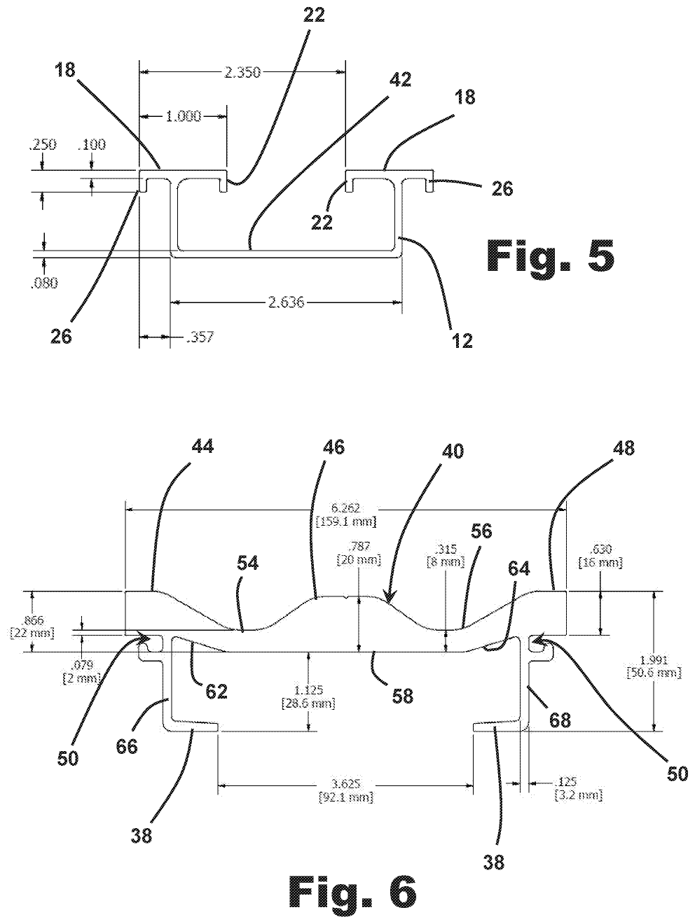

By using two bearings 10, paired, one on each side of the aluminum channel 12, it becomes easier to manufacture aluminum sub decks for moving floor systems that both use the “splash guard” hold down design concept in combination with variations in aluminum channel width. In particular, wider aluminum channels, where the width of the horizontal web 42 of the channel (see FIG. 5) is extended or expanded and thereby enables the use of wider floor slats 40.

Referring now to FIG. 6, the floor slat 40 will now be generally described. The floor slat 40 is a wider form of “triple” ridge slat in that it has raised regions 44, 46, 48 across the width of the slat. Underneath the side regions 44, 48 are seal channels 50, one on each side of the slat, which may be used to receive elongated seals 52.

In the slat configuration shown in FIG. 6, the slat 40 has channels on each side. In the configuration illustrated in FIG. 1, the seal channel 50 is on one side only. At this preliminary stage of the design, these variations are described here as potential options. The floor slat 40 also has valleys 54, 56 in between the raised regions 44, 46, 48.

The floor slat 40 shown in FIGS. 1 and 6 has a horizontal flat underside 58 that rests on the top surface 60 of each bearing 10. The underside surface 58 then angles upwardly on each side, as shown at 62, 64, respectively. The slat's side legs 66, 68 terminate with the horizontal foot 38 described earlier.

FIG. 5 includes dimensions of the aluminum channel 12 in inches. Likewise, FIG. 6 includes dimensions of the floor slat 40, in both inches and millimeters. These dimensions in combination with the “splash guard” hold down design of the bearing(s) 10, may be unique. The right to claim the dimensions in combination with other design elements is reserved, even though dimensions are illustrated in drawings and not described in the text of this disclosure.

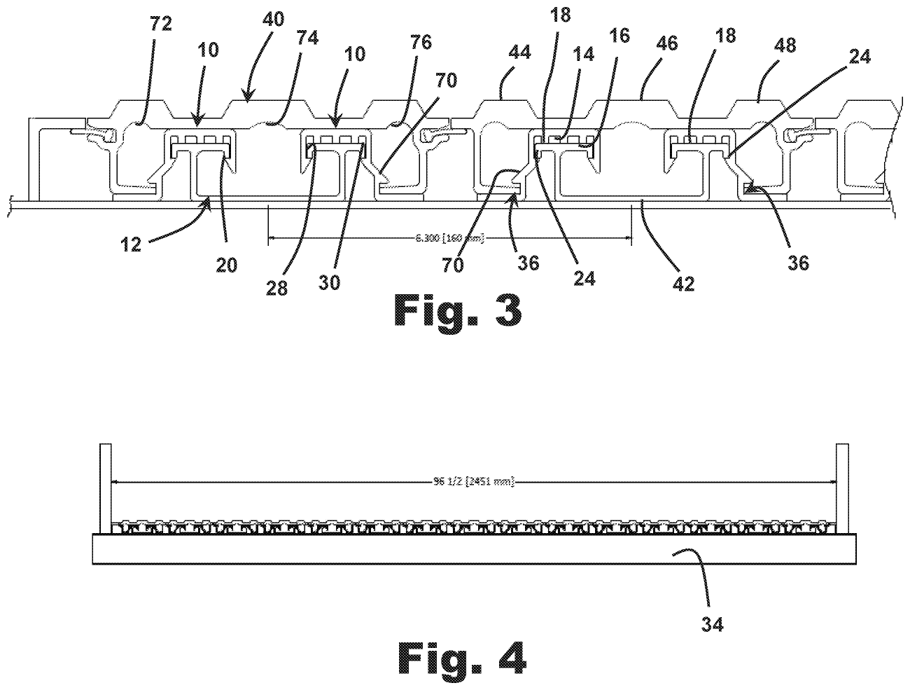

FIG. 3 illustrates modifications to the foregoing. In FIG. 3, the bearing 10 has an outwardly angled portion 70 that extends between hook 24 and notch 36. The floor slat 40 is modified such that the raised regions 44, 46, 48 have been flattened. The underside 58 of this particular slat configuration is also different in that the underside has scalloped portions 72, 74, 76 in lieu of the angles 62, 64 previously described (for the slat configuration illustrated in FIGS. 1 and 6).

FIG. 4 generally provides context for the present disclosure and illustrates how the slats and bearings described above might be arranged across the width of a moving floor installed in a trailer or the like.

It is to be appreciated that the design(s) described here are embodiments that do not define the scope of any patent right. The patent right, or rights, as the case may be, are to be defined by the patent claims that follow, as allowed by the U.S. Patent Office. The interpretation of allowed patent claims is to be made in accordance with the established doctrines of patent claim interpretation.

What is claimed is:

1. A splash guard hold down bearing for a moving floor conveyor that has a plurality of reciprocating floor slats, the bearing comprising:
a top flat portion for supporting the underside of a floor slat, wherein the top flat portion also has an underside that includes a plurality of length-wise grooves and ridges, with the ridges shaped to rest on a horizontal surface of an underlying channel member;
a first hook portion, adjacent to a side of said top flat portion, for clipping onto a region of said underlying channel member;
a sidewall portion, adjacent to another side of said top flat portion, said sidewall portion including a second hook portion for clipping onto said region of said underlying channel member, and wherein said first and second hook portions oppose each other; and further,
said sidewall portion extends downwardly and terminates as a horizontal seal portion that is shaped to rest on a member of an underlying support; and still further,
a region of said sidewall portion defines an outwardly facing notch, vertically above said horizontal seal portion, for capturing a horizontal foot of said floor slat; and wherein
said bearing is made of a plastic material that has sufficient flexibility so that said first and second hook portions can flex apart as said bearing is pushed down over said horizontal surface of said underlying channel member.

2. The bearing of claim 1, wherein said sidewall portion includes an outwardly angled region between said second hook portion and said outwardly facing notch.
